(19) United States
(12) Patent Application Publication
(10) Pub. No.: US 2010/0296027 A1
(43) Pub. Date: Nov. 25, 2010

(54) Display device

(76) Inventors: Tsutomu Matsuhira, Chiba (JP); Teruo Ebihara, Chiba (JP); Mitsuyoshi Hara, Chiba (JP)

Correspondence Address: Bruce L Adams;Adams & Wilks, 17 Battery Place, Suite 1231, New York, NY, 10004, US

(21) Appl. No.: 12/311,875

(22) PCT Filed: Oct. 16, 2007
(86) PCT No.: PCT/JP2007/070153

§ 371 Date: Apr. 16, 2009

(30) Foreign Application Priority Data
Oct. 17, 2006 (JP) 2006-282227
Nov. 17, 2006 (JP) 2006-311561

(51) Int. Cl. G02F 1/1335; G02F 1/1333

(52) U.S. Cl. 349/96; 349/158

(57) ABSTRACT

Glass plates for reinforcement are attached over an entire surface of a display region on a display surface side and its opposite side of a liquid crystal panel 30 to increase performance of a loading resistance to an impact from an outside or pressing force, whereby the liquid crystal panel 30 is allowed to be thin. Specifically, there is provided a display device including: the liquid crystal panel 30 which includes two transparent substrates sandwiching liquid crystals therebetween and an optical film placed on at least one of outer surfaces of the two transparent substrates; a first glass plate which is attached on a display surface side of the liquid crystal panel 30 through a first adhesive made of an optical adhesive or a translucent bonding sheet; and a second glass plate which is attached on a rear surface side of the liquid crystal panel 30 through a second adhesive made of the optical adhesive or the translucent bonding sheet.

### TECHNICAL FIELD

The present invention relates to a display device in which a flat display element such as a liquid crystal panel is used. In particular, the present invention relates to a structure of a display device in which a cover plate or a touch panel is arranged on a display surface side of a flat display element.

### BACKGROUND ART

A flat display device is widely put into practical use as a display portion of a cellular phone, a personal digital assistance (PDA), an electronic dictionary, a car navigation system, a music player, or the like. In particular, a display device using a liquid crystal panel is light and thin, and is used as a display portion of a personal computer or a display portion of a portable device from its characteristics of low power consumption.

FIG. 15 illustrates a cross-sectional structure of a display device using a liquid crystal panel with a touch switch. The display device includes a liquid crystal panel 50 including a liquid crystal cell in which a liquid crystal layer (not shown) is sandwiched between two transparent substrates 51 and 52, and polarizing plates 53 and 54 disposed on a surface on a display side of the liquid crystal cell and a rear surface on an opposite side thereof, and a touch switch 55 disposed in an upper portion on the display surface side. The touch switch 55 and the liquid crystal panel 50 are bonded to each other through a transparent adhesive 56 (for example, see Patent Document 1). Further, it is known to use, in place of the transparent adhesive 56, a double-sided adhesive tape having a thickness of from 0.3 mm to 0.5 mm, or 0.5 mm to 1.0 mm or larger to be disposed on an outer periphery of the liquid crystal panel 50, and to stick and fix the liquid crystal panel 50 and the touch switch 55 to each other.

As the touch switch 55, an analog resistance type, a digital resistance type, an electrostatic capacitance type, an ultrasonic wave type, or the like is used. In the analog resistance type, two transparent substrates in which transparent resistance films are formed on inner surfaces thereof are bonded so as to be opposed to each other with a space therebetween. One of the substrates of the touch switch 55 is pressed and accordingly the transparent resistance films are brought into contact with each other. Coordinates of the contact point are detected by detecting resistance values of the transparent resistance films. A backlight (not shown) is disposed on a rear surface side of the liquid crystal panel 50. Generally, the backlight is fixed on an outer periphery of a display region of the liquid crystal panel 50 with a use of a double-sided light-shielding tape having a thickness of about 0.05 mm to 0.1 mm. Further, in the liquid crystal panel 50, a driver IC for driving the liquid crystal layer is mounted onto one of the transparent substrates in some cases. The driver IC is formed of bare chips, and a gold bump provided to an electrode of a bare chip is directly faced down to an electrode of the transparent substrate through an anisotropic conductive film to thereby perform chip-on-glass (COG) mounting.

Further, in a cellular phone, generally, a transparent cover plate is disposed without using the touch switch 55 in many cases. An opaque region is formed by printing on an outer peripheral portion of a display region of the transparent cover plate. The liquid crystal panel 50 and the opaque region of the transparent cover plate are isolated from each other with an elastic member such as a rubber having a thickness of from 0.3 mm to 0.5 mm being sandwiched therebetween. Particularly, in a display device of the cellular phone, there is a strong demand for thinning by setting a gap between the transparent cover plate and the liquid crystal panel 50 to be equal to or smaller than 0.2 mm.

Here, for the transparent cover plate, a transparent plastic made of acryl or polycarbonate, glass, or the like is used. On a surface of the transparent cover plate, a low reflective film formed by laminating materials having stepwisely different refractive indexes, an electromagnetic shield made of copper, aluminum, or the like and having a lattice-like etching pattern, a hard coating for preventing scratches, and the like are provided in many cases. Moreover, in a case of using glass as the transparent cover plate, there are cases where a film sheet for preventing cracking, a film sheet which has been subjected to anti-glare processing for preventing direct reflection, or the like are attached.

The liquid crystal panel 50 and the touch switch 55 are bonded to each other as follows. An adhesive made of a resin is applied to a surface of the liquid crystal panel 50 or a rear surface of the touch switch 55. A thickness of the adhesive is set to be about 1 mm. The liquid crystal panel 50 and the touch switch 55 are attached to each other in a vacuum chamber to be bonded to each other while preventing air bubbles from entering therebetween. The transparent adhesive 56 becomes gel-like or rubber-like (for example, see Patent Document 2). Further, there is known a method of bonding the touch switch 55 and the liquid crystal panel 50 by using a liquid adhesive. In this case, they are attached to each other in the atmosphere while preventing air bubbles from entering therebetween (for example, see Patent Document 1).

Moreover, there is also known a method of bonding without using a liquid adhesive. When the liquid crystal panel 50 and a transparent protective plate are bonded to each other through a bonding sheet having a thickness of 0.2 mm, in order to prevent air bubbles from entering between the bonding surfaces, a volatile solvent is interposed in the bonding interface to obtain close contact (for example, see Patent Document 3). Besides, in order to improve repairing performance or shock absorbing performance, there is known a method of disposing, between the liquid crystal panel 50 and the transparent protective plate, a transparent sheet having a three-layer structure in which a silicone gel layer having a thickness of 3 mm is sandwiched between silicone rubber layers having a thickness of 0.1 mm, and attaching them to each other (for example, see Patent Document 4).

This type of display device is used outdoors in many cases. For example, when a display is viewed with the use of sunglasses, there is a case where an image displayed on the display device cannot be viewed depending on a viewing angle. This is because image light which passes through the liquid crystal panel 50 has polarization property and, in a case where a polarization direction of the image light and a polarization direction of the sunglasses are orthogonal to each other, the image cannot be viewed. Then, there is known a method of setting a polarization axis of the image light which is emitted from the display device so as to be shifted by 45 degrees with respect to a polarization axis of the sunglasses (for example, see Patent Document 5). Further, it is known to form the transparent cover plate of an organic material having optically anisotropic property (for example, see Patent Document 6).

### Patent Document 1: JP 09-273536 A

### Patent Document 2: JP 07-114010 A

### Patent Document 3: JP 06-075210 A

### Patent Document 4: JP 2004-101636 A

### Patent Document 5: JP 2000-292782 A

### Patent Document 6: JP 2002-350821 A

### DISCLOSURE OF THE INVENTION

### Problem to be Solved by the Invention

As a display device is made thinner, a glass substrate of a liquid crystal panel is increasingly made thinner. For example, the glass substrate is generally set to have a thickness of 0.25 to 0.20 mm. However, particularly in a portable device such as a cellular phone, there arises a problem that the glass substrate of the liquid crystal panel cracks due to a drop impact or a pressing force.

As countermeasures against glass cracking, attempts has been made to change a material of a backlight case from plastic to a material such as magnesium having large Young's modulus. However, a rear surface glass substrate of the liquid crystal panel is particularly liable to crack due to shocks. Further, the material of the glass substrate of the liquid crystal panel has been examined to be changed to plastic or a polymer film. However, reliability of gas barrier formed on a plastic substrate or a film substrate cannot be ensured, thereby being not sold commercially in large quantity.

Further, there has been examined a method of attaching a tempered glass on a display surface side of the liquid crystal panel to increase a structural strength. In this method, there has been a problem that, while a strength against an impact due to a falling ball or the like can be increased, with respect to loading due to a pressing force, the liquid crystal panel cracks earlier than the tempered glass. Specifically, due to the loading of the pressing force from the display surface side, a compressive stress is generated on the tempered glass thicker than the liquid crystal panel. Then, a tensile stress is generated on the liquid crystal panel which is bonded to a lower portion of the tempered glass, which leads to breaking. In order to avoid this, making the tempered glass much thicker or making the glass substrate of the liquid crystal panel much thicker may be sufficient, but in that case, the entire thickness of the display device is made larger, and it is difficult to realize further thinning of the display device.

Further, even if the tempered glass is attached on the display surface side of the liquid crystal panel, when a drop impact is given, there has been a problem that the liquid crystal panel is removed from a portion in which the liquid crystal panel is bonded to the backlight with a double-sided light-shielding tape and the liquid crystal panel and the tempered glass protrude outside.

Accordingly, an object of the present invention is to provide, in a thin display device, a structure in which a crack is difficult to be generated due to a drop impact or a pressing force. Further, another object of the present invention is to provide a structure in which a display panel is difficult to protrude outside due to a drop impact.

### Means for Solving the Problems

In order to achieve the above-mentioned objects, according to an aspect of the present invention, there is provided a display device including: a liquid crystal panel which includes two transparent substrates sandwiching liquid crystals therebetween and an optical film placed on at least one of outer surfaces of the two transparent substrates; a first glass plate which is attached on a display surface side of the liquid crystal panel through a first adhesive made of an optical adhesive or a translucent bonding sheet; and a second glass plate which is attached on a rear surface side of the liquid crystal panel through a second adhesive made of the optical adhesive or the translucent bonding sheet.

Further, in the display device, an outer shape of the second glass plate is larger than an outer shape of the first glass plate. Further, in the display device, a thickness of the second glass plate is larger than a thickness of the first glass plate. Further, in the display device, the second glass plate serves as a light guide plate which guides backlight to the liquid crystal panel. Further, in the display device, an optically anisotropic film is disposed between the liquid crystal panel and the first glass plate. Further, in the display device, the first adhesive is an optically anisotropic adhesive. Further, in the display device, the optically anisotropic adhesive is formed by mixing liquid crystals in a photo-curable adhesive. Further, in the display device, an anti-scattering film is placed on a surface of the first glass plate. Further, in the display device, a touch panel which is formed by attaching the first glass plate and a transparent substrate to each other through a space is disposed on the display surface side of the liquid crystal panel.

Further, in order to achieve the above-mentioned objects, according to another aspect of the present invention, there is provided a display device including: a display panel including a polarizing plate disposed on a display surface side thereof; a translucent member disposed on the display surface side; and an optical member having optical anisotropy or an optical member canceling linear polarization, which is disposed between the polarizing plate and the translucent member.

Further, in the display device, the optical member is an optically anisotropic film or a linear polarization canceling film. Further, in the display device, the optical member is an optically anisotropic adhesive or an optically anisotropic bonding sheet, and the display panel and the translucent member are bonded to each other over an entire surface of a display region of the display panel through the polarizing plate. Further, in the display device, the translucent member is a glass plate, a translucent plastic plate, or a touch panel. Further, in the display device, a touch panel formed by attaching two transparent substrates to each other through a space is disposed on the display surface side of the display panel, and at least one of the two transparent substrates is formed of the optical member. Further, in the display device, the touch panel and the display panel are bonded to each other over the entire surface of the display region of the display panel with a use of an optical adhesive.

### EFFECTS OF THE INVENTION

The display device of the present invention includes: a liquid crystal panel which includes two transparent substrates sandwiching liquid crystals therebetween and an optical film placed on at least one of outer surfaces of the two transparent substrates; a first glass plate which is attached on a display surface side of the liquid crystal panel through a first adhesive made of an optical adhesive or a translucent bonding sheet; and a second glass plate which is attached on a rear surface side of the liquid crystal panel through a second adhesive made of the optical adhesive or the translucent bonding sheet. With this, it is possible to provide a display device which is hard to crack with respect to an impact from the outside or a pressing force and can be thinned. Further, the outer shape of the glass plate which is attached to the rear surface is made larger than the outer shape of the glass plate which is attached to the surface, and accordingly it is possible to provide a display device in which the liquid crystal panel is suppressed from protruding due to the impact from the outside.

### BRIEF DESCRIPTION OF THE DRAWINGS

FIG. 1 is a schematic longitudinal sectional view illustrating a display device according to a first embodiment of the present invention.

FIG. 2 is a schematic longitudinal sectional view illustrating a display device according to a second embodiment of the present invention.

FIG. 3 is a schematic longitudinal sectional view illustrating a display device according to a third embodiment of the present invention.

FIG. 4 is a schematic longitudinal sectional view illustrating a display device according to a fourth embodiment of the present invention.

FIG. 5 is a schematic longitudinal sectional view illustrating a display device according to a fifth embodiment of the present invention.

FIG. 6 is a schematic longitudinal sectional view illustrating a display device according to a sixth embodiment of the present invention.

FIG. 7 is a schematic longitudinal sectional view illustrating a display device according to a seventh embodiment of the present invention.

FIG. 8 is a schematic longitudinal sectional view illustrating a display device according to an eighth embodiment of the present invention.

FIG. 9 is a schematic longitudinal sectional view illustrating a display device according to a ninth embodiment of the present invention.

FIG. 10 is a schematic longitudinal sectional view illustrating a display device according to a tenth embodiment of the present invention.

FIG. 11 is a schematic longitudinal sectional view illustrating a display device according to an eleventh embodiment of the present invention.

FIG. 12 is a schematic longitudinal sectional view illustrating a display device according to a twelfth embodiment of the present invention.

FIG. 13 is a schematic longitudinal sectional view illustrating a display device according to a thirteenth embodiment of the present invention.

FIG. 14 is a schematic longitudinal sectional view illustrating a display device according to a fourteenth embodiment of the present invention.

FIG. 15 is a schematic longitudinal sectional view illustrating a conventionally-known display device.

### DESCRIPTION OF SYMBOLS

1, 2, 19 glass substrate
3, 4 polarizing plate
5, 7 tempered glass
6, 8 optical adhesive
9 film
10 reflective film
11 LED
12 light guide plate
13 acrylic plate
14 driver IC
15 optically anisotropic film
20 spacer
21 transparent substrate
22 touch panel
30 liquid crystal panel

### BEST MODE FOR CARRYING OUT THE INVENTION

### First Embodiment

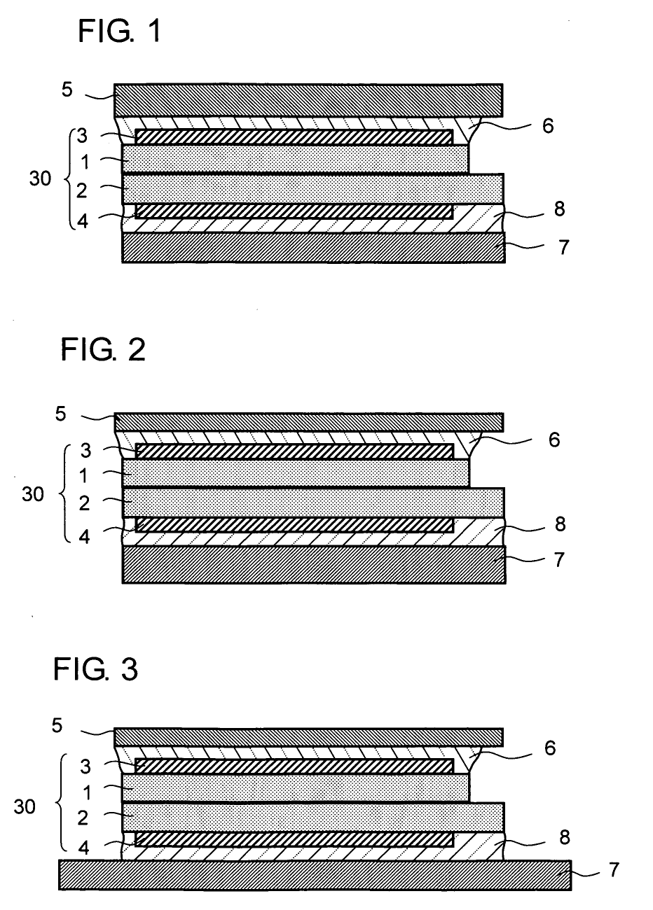

FIG. 1 is a schematic longitudinal sectional view illustrating a display device according to a first embodiment of the present invention. FIG. 1 illustrates a liquid crystal panel 30 structured by including a glass substrate 1 which is a transparent substrate on a display surface side, a glass substrate 2 which is a transparent substrate on a rear surface side, a liquid crystal layer (not shown) sandwiched between the glass substrate 1 and the glass substrate 2, a polarizing plate 3 which serves as an optical film attached to a display surface side of the glass substrate 1, and a polarizing plate 4 which serves as an optical film attached to a rear surface side of the glass substrate 2. On the display surface side of the liquid crystal panel 30, a tempered glass 5 which serves as a first glass plate is bonded with an optical adhesive 6 which serves as a first adhesive having light transmissive property. Also on the rear surface side of the liquid crystal panel 30, a tempered glass 7 which serves as a second glass plate is bonded with an optical adhesive 8 which serves as a second adhesive. The optical adhesives 6 and 8 are formed over at least the entire surface of a display region of the liquid crystal panel 30, in which letters or images are displayed.

Here, the tempered glass 5 on the display surface side and the tempered glass 7 on the rear surface side each have a thickness of 0.5 mm. The optical adhesive 6 and the optical adhesive 8 each have a thickness of about 100 μm. The glass substrates 1 and 2 forming the liquid crystal panel 30 each have a thickness of 0.2 mm. A color filter and a transparent electrode are formed on a surface on a liquid crystal layer side of the glass substrate 1. A thin film transistor (TFT) array is formed on a surface on a liquid crystal layer side of the glass substrate 2. The TFT array inputs a drive signal and a video signal from a driver IC (not shown) to drive the liquid crystal layer. Light that passes through the polarizing plate 4 and enters the liquid crystal layer changes its oscillation direction according to the video signal applied to the liquid crystal layer, thereby being visualized by the polarizing plate 3.

Note that the polarizing plates 3 and 4 do not necessarily need to be attached to the glass substrate 1 and the glass substrate 2 directly. The polarizing plates 3 and 4 may be disposed in positions away from the glass substrates 1 and 2. For example, the polarizing plate 3 may be attached on a tempered glass 5 side, and the polarizing plate 4 may be attached on a tempered glass 7 side. In a description described below, the polarizing plates 3 and 4 are included to refer to the liquid crystal panel 30.

The two tempered glasses 5 and 7 sandwich the liquid crystal panel 30 through the optical adhesives 6 and 8 to bond and fix the entire surface of the display region, whereby performance of a loading resistance to a drop impact or a pressing force such as a falling ball on a display surface is increased to a large extent and occurrence of cracking of the liquid crystal panel 30 is reduced, even when the total thickness of the two glass substrates 1 and 2 is about 0.4 mm, which is extremely thin as the liquid crystal panel 30.

Note that, in place of the optical adhesives 6 and 8, a translucent bonding sheet may be used to bond and fix the liquid crystal panel 30 and the tempered glass 5 or 7. The translucent bonding sheet is cut in a size of the liquid crystal panel 30 to be arranged between the tempered glass 5 or 7 and the liquid crystal panel 30 in which the polarizing plates 3 and 4 are disposed. Then, the liquid crystal panel 30 and the tempered glasses 5 and 7 are pressed upwardly and downwardly of both the tempered glasses 5 and 7 and can be bonded to one another. In other wards, they can be bonded with ease.

Further, an optically anisotropic film is disposed between the tempered glass 5 and the liquid crystal panel 30, or disposed on a surface of the tempered glass 5, opposite to the liquid crystal panel 30 to thereby prevent that a display cannot be viewed when the display surface is viewed with the use of sunglasses or the like having polarization property. As the optically anisotropic film, a drawn film having high transparency may be used.

The optically anisotropic film desirably has characteristics of a ¼λ phase difference plate. The film is disposed so that a drawing axis thereof is at an angle of about 45 degrees with respect to a polarization axis of the polarizing plate 3. With this, image light having linear polarization property which has passed through the polarizing plate 3 is converted into circular polarization or elliptical polarization. As a result, even when a displayed image is viewed with the use of sunglasses or the like having polarization property, it may be prevented that the image cannot be viewed. As materials for the optically anisotropic film, for example, cycloolefin polymer (hereinafter, referred to as COP), polycarbonate, polyethylene terephthalete (hereinafter, referred to as PET), and the like may be used.

Further, as the optical adhesive 6 serving as the first adhesive, an optically anisotropic adhesive may be used. The optically anisotropic adhesive has, for example, property of a ¼λ wavelength plate, or similar thereto, and may reduce a polarization ratio of the linear polarization. Through this property, as in a case where the optically anisotropic film is used, even when image light is viewed with the use of glasses such as sunglasses having polarization property, it may be prevented that a displayed image cannot be viewed. As the optically anisotropic adhesive, a photo-curable adhesive in which liquid crystals are mixed may be used. A refractive index of the photo-curable adhesive and a refractive index of the liquid crystals are made substantially equal to each other, whereby transparency can be obtained. In a case of photo-curing, the liquid crystals are heated to be liquefied, and are irradiated with light to be cured at the same time. Further, the photo-curable adhesive in which a base resin is a liquid crystal polymer type is subjected to orientation processing in advance on a bonding surface to be cured, whereby optical anisotropy may be imparted. Alternatively, the photo-curable adhesive is irradiated with light of linear polarization to be cured, whereby optical anisotropy may be imparted.

Further, an anti-scattering film may be attached to the surface of the tempered glass 5. With this, it can be prevented that the tempered glass 5 is broken and pieces of the broken glass are scattered in a case where there occurs a strong impact or a strong pressing force applied to the display surface. Moreover, the anti-scattering film is provided with property of optical anisotropy, whereby it can be prevented that a display cannot be viewed even with the use of glasses or the like having polarization property.

### Second Embodiment

FIG. 2 is a schematic longitudinal sectional view illustrating a display device according to a second embodiment of the present invention. The second embodiment is different from the first embodiment of FIG. 1 in thicknesses of a tempered glass 5 serving as a first glass plate, a tempered glass 7 serving as a second glass plate, and a liquid crystal panel 30. Other structures are similar to those of the first embodiment of FIG. 1, and therefore different parts are mainly described below. The same parts or parts having the same functions are denoted by the same reference numerals.

As illustrated in FIG. 2, the liquid crystal panel 30 is formed of two glass substrates 1 and 2, a liquid crystal layer (not shown), and polarizing plates 3 and 4. A display surface side of the liquid crystal panel 30 and the tempered glass 5 are bonded and fixed to each other through an optical adhesive 6 serving as a first adhesive, and a rear surface side of the liquid crystal panel 30 and the tempered glass 7 are bonded and fixed to each other through an optical adhesive 8 serving as a second adhesive.

A thickness of the glass substrate 1 forming the liquid crystal panel 30 is set to 0.15 mm, and a thickness of the glass substrate 2 is set to 0.2 mm. Accordingly, the total thickness of the two glass substrates 1 and 2 is about 0.35 mm, and the liquid crystal panel 30 is formed to be extremely thin. The tempered glass 5 having a thickness of 0.3 mm is bonded and fixed to the display surface side of the liquid crystal panel 30 through the optical adhesive 6. The tempered glass 7 having a thickness of 0.6 mm is bonded and fixed to the rear surface side of the liquid crystal panel 30 through the optical adhesive 8. The optical adhesives 6 and 8 are formed over the entire display surfaces of the liquid crystal panel 30. The thickness of each of the optical adhesives 6 and 8 is set to about 100 μm. Other structures are similar to those of the first embodiment illustrated in FIG. 1, and therefore descriptions thereof are omitted.

In other words, the tempered glass 5 bonded to the display surface side is set to have a thickness larger than that of the tempered glass 7 bonded to the rear surface side. The tempered glass 5 on the display surface side is disposed so as to enhance shock resistance mainly, and the tempered glass 7 on the rear surface side is disposed so as to enhance load resistance due to a pressing force mainly. With this, even when the liquid crystal panel 30 is made thinner, performance of a loading resistance to a drop impact or a pressing force of a falling ball or the like is increased to thereby reduce cracking of the liquid crystal panel 30.

Further, in place of the optical adhesive 6 serving as the first adhesive, a translucent bonding sheet may be used. In addition, similarly to the first embodiment described above, an optically anisotropic film may be disposed on a tempered glass 5 side, the optical adhesive 6 may be changed for an optically anisotropic adhesive, and an anti-scattering film may be disposed on a surface of the tempered glass 7.

### Third Embodiment

FIG. 3 is a schematic longitudinal sectional view illustrating a display device according to a third embodiment of the present invention. The third embodiment is different from the second embodiment of FIG. 2 in a thickness of a glass substrate 1 forming a liquid crystal panel 30, and an outer shape of a tempered glass 7. Accordingly, different parts therebetween are mainly described below. The same parts or parts having the same functions are denoted by the same reference numerals.

As illustrated in FIG. 3, the liquid crystal panel 30 is formed of two glass substrates 1 and 2, a liquid crystal layer (not shown), and polarizing plates 3 and 4. A display surface side of the liquid crystal panel 30 and a tempered glass 5 serving as a first glass plate are bonded and fixed to each other through an optical adhesive 6 serving as a first adhesive, and a rear surface side of the liquid crystal panel 30 and a tempered glass 7 serving as a second glass plate are bonded and fixed to each other through an optical adhesive 8 serving as a second adhesive.

A thickness of the glass substrate 1 forming the liquid crystal panel 30 is set to 0.1 mm, and a thickness of the glass substrate 2 is set to 0.2 mm. Accordingly, the total thickness of the two glass substrates 1 and 2 is about 0.3 mm, and the liquid crystal panel 30 is formed to be thinner than that of the second embodiment described above. The tempered glass 5 having a thickness of 0.3 mm is bonded and fixed to the display surface side of the liquid crystal panel 30 through the optical adhesive 6. The tempered glass 7 having an outer shape larger than that of the liquid crystal panel 30 or the tempered glass 5 is bonded and fixed to the rear surface side of the liquid crystal panel 30 through the optical adhesive 6. A thickness of the tempered glass 7 is set to 0.6 mm. A thickness of each of the optical adhesives 6 and 8 is set to about 100 μm. Other structures are similar to those of the first embodiment described above, and therefore descriptions thereof are omitted.

The outer shape of the tempered glass 7 which is a second glass plate is formed to be larger than an outer shape of the liquid crystal panel 30 or the tempered glass 5, and hence, in a case where the display device is mounted in a cellular phone or the like, an elastic member such as a cushion may be interposed between a display surface cover of a casing and the tempered glass 7 to thereby fix the display device. The outer shape of the tempered glass 7 is larger than an outer shape of a display window which is disposed on the display surface cover of the casing, and accordingly the liquid crystal panel 30 may be prevented from falling out from the display window in a case of receiving an impact from the outside.

In addition, similarly to the first embodiment described above, a translucent bonding sheet may be used in place of the optical adhesive, an optically anisotropic film may be disposed on a tempered glass 5 side, the optical adhesive 6 may be changed for an optically anisotropic adhesive, and an anti-scattering film may be disposed on a surface of the tempered glass 7.

### Fourth Embodiment

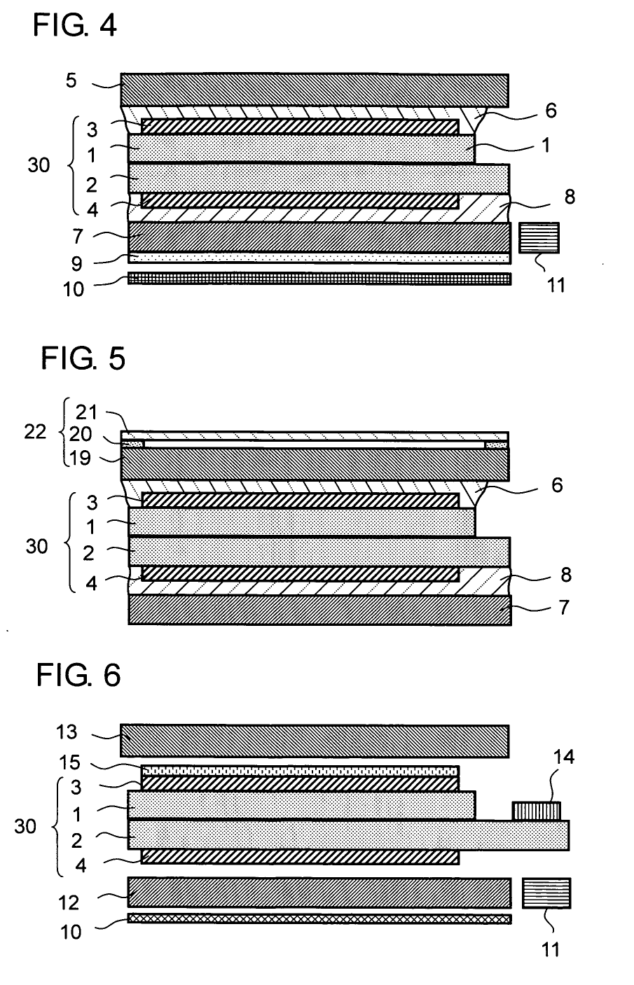

FIG. 4 is a schematic longitudinal sectional view illustrating a display device according to a fourth embodiment of the present invention. The same parts or parts having the same functions are denoted by the same reference numerals.

In FIG. 4, a liquid crystal panel 30 is formed of a glass substrate 1 and a glass substrate 2, a liquid crystal layer (not shown) sandwiched between the two glass substrates 1 and 2, a polarizing plate 3 attached on a display surface side of the glass substrate 1, and a polarizing plate 4 attached on a rear surface side of the glass substrate 2. The liquid crystal panel 30 and a tempered glass 5 serving as a first glass plate are bonded and fixed to each other over the entire display surface through an optical adhesive 6 serving as a first adhesive, and the liquid crystal panel 30 and a tempered glass 7 serving as a second glass plate are bonded and fixed to each other over the entire display surface through an optical adhesive 8 serving as a second adhesive. A reflective film 10 having a rear surface on which a reflective coat made of Ag or the like is formed is disposed on a lower portion of the tempered glass 7. An LED 11 which serves as a light emitting source is disposed in the vicinity of a side end surface of the tempered glass 7. A film 9 for irradiating the liquid crystal panel 30 disposed above with light introduced from the side end surface as a uniform surface emission is attached to a rear surface of the tempered glass 7. On a surface of the film 9, a pattern for obtaining the uniform surface emission is formed. In other words, the tempered glass 7 functions as a light guide plate.

Here, the glass substrates 1 and 2 forming the liquid crystal panel 30 are each set to have a thickness of 0.1 mm. Accordingly, the total thickness of the glass substrates 1 and 2 is about 0.2 mm, which is thinner than in the third embodiment. A thickness of the tempered glass 5 on the display surface side is set to 0.3 mm, and a thickness of the tempered glass 7 on the rear surface side is set to 0.5 mm. A thickness of each of the optical adhesives 6 and 8 is set to about 100 μm.

With the structure described above, the tempered glass 7 functions as a reinforcing plate for the liquid crystal panel 30 and also functions as the light guide plate for guiding light to the liquid crystal panel 30. For that reason, the display device may be made thinner by a thickness of the light guide plate for a backlight. At the same time, performance of a loading resistance to a drop impact or a pressing force of a falling ball or the like is increased to thereby reduce cracking of the liquid crystal panel 30.

In addition, similarly to the first embodiment described above, a translucent bonding sheet may be used in place of the optical adhesive, an optically anisotropic film may be disposed on a tempered glass 5 side, the optical adhesive 6 may be changed for an optically anisotropic adhesive, and an anti-scattering film may be disposed on a surface of the tempered glass 7.

### Fifth Embodiment

FIG. 5 is a schematic longitudinal sectional view illustrating a display device according to a fifth embodiment of the present invention. In this embodiment, a touch panel is formed on a display surface side of a liquid crystal panel 30. The same parts or parts having the same functions are denoted by the same reference numerals.

In FIG. 5, the liquid crystal panel 30 is formed of glass substrates 1 and 2, a liquid crystal layer (not shown) sandwiched between the two glass substrates 1 and 2, a polarizing plate 3 attached on a display surface side of the glass substrate 1, and a polarizing plate 4 attached on a rear surface side of the glass substrate 2. A touch panel 22, which includes a glass substrate 19 serving as a first glass substrate and a transparent substrate 21 attached thereto with a space formed by a spacer 20, is disposed on the display surface side of the liquid crystal panel 30. The glass substrate 19 of the touch panel 22 is bonded on the display surface side of the liquid crystal panel 30 through an optical adhesive 6 serving as a first adhesive. A tempered glass 7 serving as a second glass plate is bonded on the rear surface side of the liquid crystal panel 30 through an optical adhesive 8 serving as a second adhesive. The optical adhesives 6 and 8 are applied over at least the entire surface of a display region of the liquid crystal panel 30, in which letters or images are displayed. In other words, the glass substrate 19 forming the touch panel 22 functions as a tempered glass for protecting the liquid crystal panel 30 against an impact or a pressing force.

Here, a thickness of the glass substrate 19 forming the touch panel 22 is set to about 1 mm. The transparent substrate 21 forming the touch panel 22 is a PET film. Transparent conductive films (not shown) are formed on inner surfaces of the glass substrate 19 and the transparent substrate 21, and connected to an external resistance detection circuit. When a transparent substrate 21 side is pressed from the outside, the transparent conductive films are brought into contact with each other. This contact point is detected by the resistance detection circuit to detect a position of the contact point.

A thickness of each of the glass substrates 1 and 2 forming the liquid crystal panel 30 is set to 0.2 mm. A thickness of each of the optical adhesives 6 and 8 is set to about 100 μm. A thickness of the tempered glass 7 is set to 0.5 mm. A color filter and a transparent electrode are formed on a surface on a liquid crystal layer side of the glass substrate 1. A TFT array is formed on a surface on a liquid crystal layer side of the glass substrate 2. With this structure, even when an external stress such as a drop impact or a pressing force is applied, cracking of the liquid crystal panel 30 can be reduced.

Note that the polarizing plates 3 and 4 do not necessarily need to be attached to the glass substrate 1 and the glass substrate 2 directly. The polarizing plates 3 and 4 may be disposed in positions away therefrom. For example, the polarizing plate 3 may be attached on a tempered glass 5 side, and the polarizing plate 4 may be attached on a tempered glass 7 side. In addition, similarly to the first embodiment described above, a translucent bonding sheet may be used in place of the optical adhesives 6 and 8, an optically anisotropic film may be disposed on a tempered glass 19 side, the optical adhesive 6 may be changed for an optically anisotropic adhesive, and an anti-scattering film may be disposed on a surface of a tempered glass 5.

Further, in the first embodiment to the fifth embodiment described above, the first adhesive (optical adhesive 6) is interposed between the first glass substrate (tempered glass 5 and glass substrate 19) for reinforcing the liquid crystal panel and the liquid crystal panel 30, and the second adhesive (optical adhesive 8) is interposed between the liquid crystal panel 30 and the second glass substrate (tempered glass 7). Accordingly, because refractive indexes of the first adhesive and the second adhesive are closer to refractive indexes of the polarizing plate and the glass plate than a refractive index of air, reflection loss of light in respective interfaces is reduced and visibility of a displayed image is increased.

Next, with reference to FIGS. 6 to 14, display devices having increased visibility are described.

When a cellular phone or the like is used outside a room and an image displayed on a display device is observed with the use of sunglasses, the image may not be viewed in some cases depending on a viewing angle. Further, when an image displayed on a display device is taken with the use of a camera-equipped cellular phone, the same image cannot be taken between respective angles owing to dependence on shooting angle. Further, when a transparent plate formed of an organic material having property of optical anisotropy is used, a color balance is broken owing to a tinge of color. When a transparent plate is formed by molding, the optical anisotropy is liable to be non-uniform in the vicinity of a gate injection hole formed for the molding. Further, when an optical axis of a polarizing plate on a display surface side is set to 45 degrees, an angle of an optimum contrast may be different from a viewing angle of a user depending on liquid crystal systems. Moreover, the transparent plate formed of the organic material is liable to be broken, and in a case of a chemical tempered glass having high strength, a displayed image can not be viewed through sunglasses, which causes a problem.

Then, in the embodiments described below, there is described a display device in which, even when a touch panel or a cover plate disposed on a surface of a display surface side is formed of an organic material, a glass, or a tempered glass, an angle, at which a displayed image is difficult to be viewed even through sunglasses or a camera, is not generated.

### Sixth Embodiment

FIG. 6 is a schematic longitudinal sectional view illustrating a display device according to a sixth embodiment of the present invention. The same parts or parts having the same functions are denoted by the same reference numerals.

In FIG. 6, a liquid crystal panel 30 is formed of a glass substrate 1 and a glass substrate 2, a liquid crystal layer (not shown) sandwiched between the two glass substrates 1 and 2, a polarizing plate 3 attached on a display surface side of the glass substrate 1, and a polarizing plate 4 attached on a rear surface side of the glass substrate 2. A driver IC 14 for driving liquid crystals is mounted in the vicinity of a liquid crystal layer side of the glass substrate 2. There are disposed a light guide plate 12 and a reflective film 10 therebelow on a rear surface side of the liquid crystal panel 30. An LED 11 which is a light source is disposed on an end portion of the light guide plate 12. Light that enters from the end portion of the light guide plate 12 is reflected by a pattern (not shown) formed on a surface of the light guide plate 12 or the reflective film formed therebelow and converted into surface emission to be emitted to the liquid crystal panel 30 formed thereabove. Note that the polarizing plate 4 may be one obtained by laminating a light absorption type polarizing plate and a light reflection type polarizing plate.

An acrylic plate 13 having optical isotropy is disposed on a display surface side of the liquid crystal panel 30 as a cover plate. An optically anisotropic film 15 is disposed on the polarizing plate 3. In the optically anisotropic film 15, COP was drawn to orient molecules in a certain direction, and this drawing axis was set to an angle of 45 degrees with respect to a polarization axis of the polarizing plate 3. With this, a polarized light beam that enters from the polarizing plate 3 is converted into circular polarization or elliptical polarization by the optically anisotropic film 15. Accordingly, even when a displayed image is viewed through sunglasses or a camera having polarization property, angle dependence of the displayed image is reduced. A material for the optically anisotropic film 15 is not limited to COP, and a material having optically high transparency such as polycarbonate or PET may be used. The optically anisotropic film 15 is desirably a film having property of a ¼λ phase difference plate.

In this embodiment, the acrylic plate 13 is disposed on the uppermost portion on the display surface side. Instead of this, a tempered glass or polycarbonate may be used. Further, instead of the acrylic plate 13, a touch panel may be disposed. For the touch panel, various types such as an analog type, an ultrasonic wave type, and an electrostatic capacitance type may be used.

### Seventh Embodiment

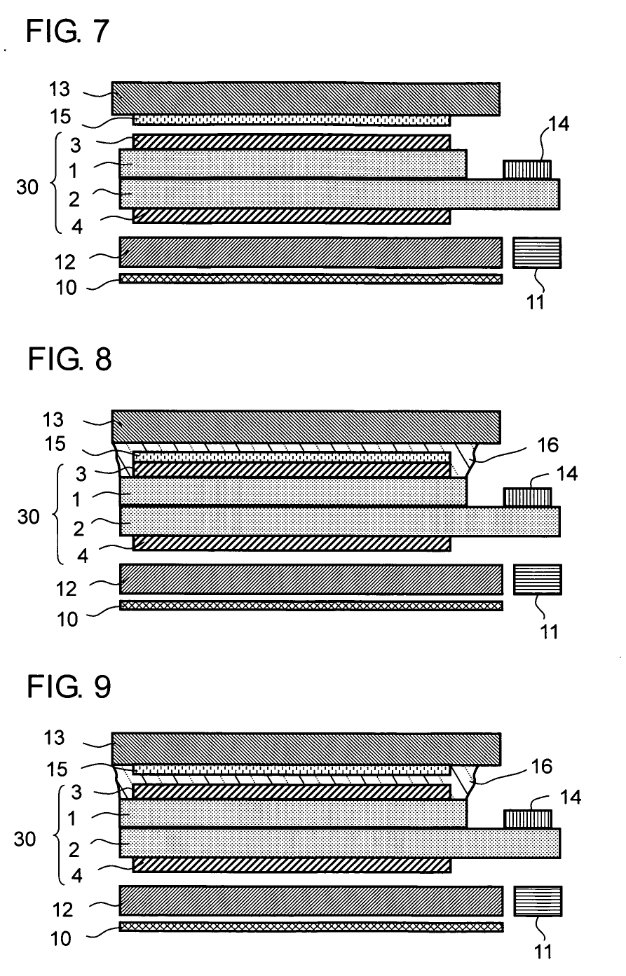

FIG. 7 is a schematic longitudinal sectional view illustrating a display device according to a seventh embodiment of the present invention. The same parts or parts having the same functions are denoted by the same reference numerals.

In FIG. 7, an optically anisotropic film 15 is disposed on a liquid crystal panel 30 side of an acrylic plate 13. This embodiment is different from the sixth embodiment of FIG. 6 in a position in which the optically anisotropic film 15 is disposed. Other structures are the same as those of the sixth embodiment. Accordingly, for parts having the same structure, description thereof is omitted.

The optically anisotropic film 15 is disposed on a surface on the liquid crystal panel 30 side of an acrylic plate 13 instead of a surface of the polarizing plate 3. In the optically anisotropic film 15, COP was drawn to orient molecules in a certain direction, and this drawing axis was set to an angle of about 45 degrees with respect to a polarization axis of a polarizing plate 3. With this, a polarized light beam that enters from the polarizing plate 3 is converted into circular polarization or elliptical polarization by the optically anisotropic film. Accordingly, even when a displayed image is viewed through sunglasses or a camera having polarization property, angle dependence of the displayed image is reduced. A material for the optically anisotropic film 15 is not limited to COP, and a material having optically high transparency such as polycarbonate or PET may be used. The optically anisotropic film 15 is desirably a film having property of a ¼λ phase difference plate. In addition, instead of the acrylic plate 13, a tempered glass, polycarbonate, or a touch panel may be used.

### Eighth Embodiment

FIG. 8 is a schematic sectional view illustrating a display device according to an eighth embodiment of the present invention. The same parts or parts having the same functions are denoted by the same reference numerals. In FIG. 8, an optically anisotropic film 15 is disposed on a surface of a polarizing plate 3 of a liquid crystal panel 30, and an acrylic plate 13 is bonded and fixed to a display surface side of the liquid crystal panel 30 through an optically isotropic adhesive 16. Other structures are the same as in the sixth embodiment illustrated in FIG. 6, and therefore descriptions thereof are omitted.

Here, the optically isotropic adhesive 16 is formed over the entire surface of a display region of the liquid crystal panel 30. A refractive index of the optically isotropic adhesive 16 is substantially the same as that of the acrylic plate 13, and with respect to a polarizing plate 3, the refractive index of the optically isotropic adhesive 16 is closer to that of the polarizing plate 3 than that of the air. Accordingly, in respective interfaces between the acrylic plate 13 and the optically isotropic adhesive and between the optically isotropic adhesive 16 and the polarizing plate 3, reflection loss of light is reduced, and display surface glare and reflection loss of light emitted from backlight are reduced to thereby increase visibility of display.

The optically anisotropic film 15 is similar to that of the seventh embodiment, and COP, polycarbonate, or PET which has optically high transparency may be used. In particular, the optically anisotropic film 15 is desirably a film having property of a ¼λ phase difference plate. In addition, instead of the acrylic plate 13, a tempered glass, polycarbonate, or a touch panel may be used.

### Ninth Embodiment

FIG. 9 is a schematic sectional view illustrating a display device according to a ninth embodiment of the present invention. The same parts or parts having the same functions are denoted by the same reference numerals. In FIG. 9, the ninth embodiment is different from the eighth embodiment of FIG. 8 in that the optically anisotropic film 15 is transferred on the liquid crystal panel 30 side of the acrylic plate 13 from on the polarizing plate 3. Other structures are the same as those of the eighth embodiment, and therefore descriptions thereof are omitted.

### Tenth Embodiment

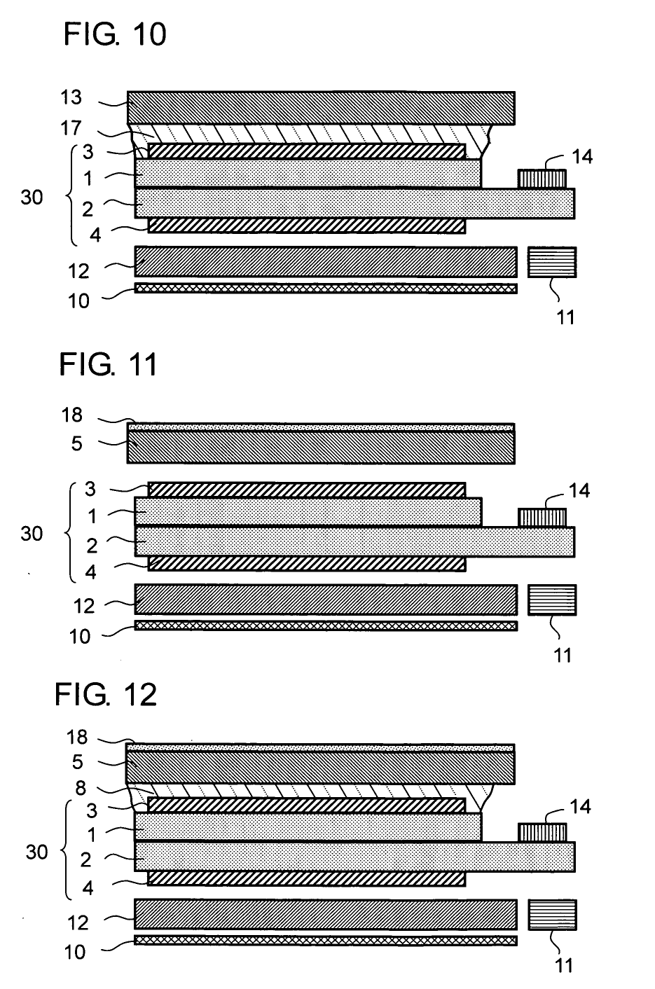

FIG. 10 is a schematic sectional view illustrating a display device according to a tenth embodiment of the present invention. The same parts or parts having the same functions are denoted by the same reference numerals.

In FIG. 10, the structure of the liquid crystal panel 30 and the structures of the light guide plate 12, the LED 11, and the reflective film 10 are similar to those of other embodiments, and therefore descriptions thereof are omitted. The liquid crystal panel 30 and the acrylic plate 13 are bonded and fixed to each other through an optically anisotropic adhesive 17. The optically anisotropic adhesive 17 is formed over the entire surface of the display region of the liquid crystal panel 30. A refractive index of the optically anisotropic adhesive 17 is substantially the same as that of the acrylic plate 13, and with respect to the polarizing plate 3, a refractive index of the optically anisotropic adhesive 17 is closer to that of the polarizing plate 3 than in a case of air. Accordingly, in respective interfaces between the acrylic plate 13 and the optically anisotropic adhesive 17 and between the optically anisotropic adhesive 17 and the polarizing plate 3, reflection loss of light is reduced, and surface glare and reflection loss of light emitted from backlight are reduced to thereby increase visibility of display.

As the optically anisotropic adhesive 17, a photo-curable adhesive in which liquid crystals are mixed may be used. A refractive index of the photo-curable adhesive and refractive indexes of the liquid crystals are made substantially equal to each other, whereby transparency can be obtained. In a case of photo-curing, the liquid crystals are heated to be liquefied, and are irradiated with light to be cured at the same time. Further, the photo-curable adhesive in which a base resin is a liquid crystal polymer type is subjected to orientation processing in advance on a bonding surface to be cured, whereby optical anisotropy may be imparted. Alternatively, the photo-curable adhesive is irradiated with light of linear polarization to be cured, whereby optical anisotropy may be imparted. In addition, instead of the acrylic plate 13, a tempered glass, polycarbonate, or a touch panel may be used, as described above.

### Eleventh Embodiment

FIG. 11 is a schematic longitudinal sectional view illustrating a display device according to an eleventh embodiment of the present invention. The same parts or parts having the same functions are denoted by the same reference numerals.

In FIG. 11, a tempered glass 5 is disposed on an upper portion on a display surface side of the liquid crystal panel 30, and an anti-scattering film 18 is disposed on the tempered glass 5. The structure of the liquid crystal panel 30 and the structures of the light guide plate 12, the LED 11, and the reflective film 10 are similar to those of other embodiments, and therefore descriptions thereof are omitted.

As the anti-scattering film 18, a PET film is attached. The PET film is subjected to drawing processing to have optical anisotropy. The PET film is disposed so that a drawing axis thereof is at an angle of about 45 degrees with respect to a polarization axis of a polarizing plate 3. Further, without being limited to PET, a material having high transparency such as polycarbonate or COP may be used. For optical anisotropy, it is desirable to have property of a ¼λ phase difference plate.

As described above, the anti-scattering film 18 is disposed on a surface of the tempered glass 5, whereby it can be prevented that, even when the tempered glass 5 or the liquid crystal panel 30 is broken due to a strong impact from the outside, broken glasses are scattered to the outside. Further, because the anti-scattering film 18 has optical anisotropy, angle dependence of a displayed image is reduced even when the displayed image is viewed through sunglasses or a camera having polarization property.

### Twelfth Embodiment

FIG. 12 is a schematic sectional view illustrating a display device according to a twelfth embodiment of the present invention. The same parts or parts having the same functions are denoted by the same reference numerals.

In FIG. 12, a tempered glass 5 is disposed on a liquid crystal panel 30, and an anti-scattering film 18 is disposed thereon. The liquid crystal panel 30 and the tempered glass 5 are bonded and fixed to each other through an optical adhesive 8. The optical adhesive 8 is formed over the entire surface of an effective display region of the liquid crystal panel 30. The liquid crystal panel 30, the light guide plate 12, the LED 11, and the reflective film are similar to those as described above, and therefore descriptions thereof are omitted.

The optical adhesive 8 having translucency is formed between the tempered glass 5 and the liquid crystal panel 30, and thus a shock resistance to a drop impact or the like and a loading resistance to a pressing force from the display surface side can be increased. Further, because a refractive index of the optical adhesive 8 is closer to a refractive index of the tempered glass 5 or the polarizing plate 3 than a refractive index of air, reflection loss in interfaces between the optical adhesive 8 and the tempered glass 5 and between the optical adhesive 8 and the polarizing plate 3 may be reduced. Accordingly, surface glare and reflection loss of transmitted light can be reduced to thereby increase visibility. Moreover, the anti-scattering film 18 or the optical adhesive 8 is formed as an optically anisotropic film or an optically anisotropic layer, and is set to be at an optimum angle with respect to a polarization axis of the polarizing plate 3, whereby angle dependence of a displayed image can be reduced in a case where the displayed image is viewed through sunglasses or the like having polarization property.

### Thirteenth Embodiment

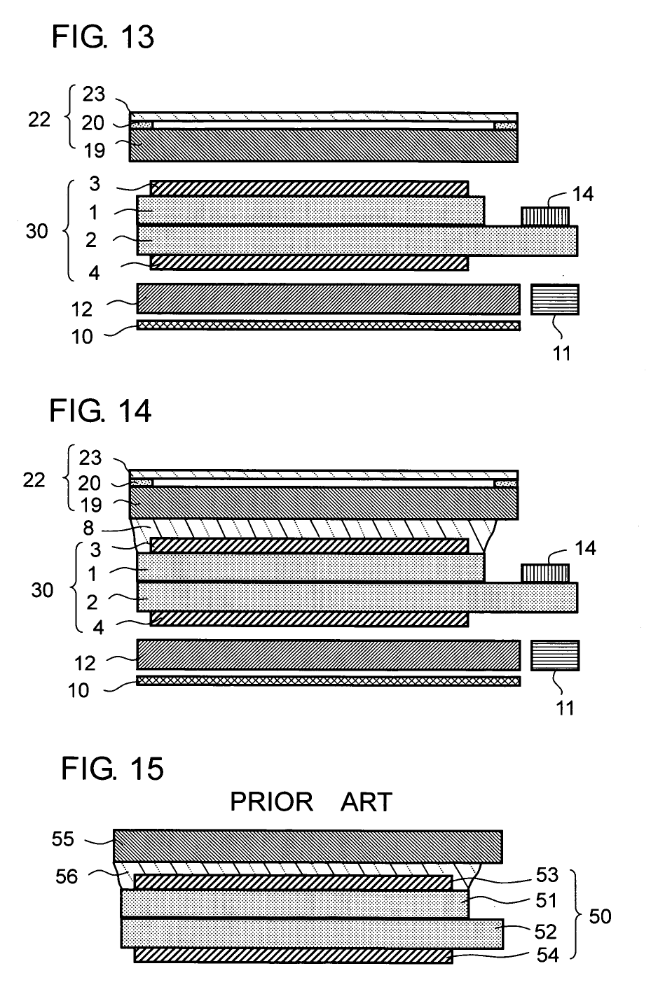

FIG. 13 is a schematic longitudinal sectional view illustrating a display device according to a thirteenth embodiment of the present invention. The same parts or parts having the same functions are denoted by the same reference numerals.

In FIG. 13, the display device includes a liquid crystal panel 30, a light guide plate 12 disposed on a lower portion thereof, an LED 11 disposed on a side end portion of the light guide plate 12, a reflective film 10 disposed on a lower portion of the light guide plate 12, and a touch panel 22 disposed on an upper portion of the liquid crystal panel 30. The liquid crystal panel 30, the light guide plate 12, the LED 11, and the reflective film 10 are similar to those of the sixth to twelfth embodiments, and therefore descriptions thereof are omitted.

The touch panel 22 includes a glass substrate 19 and an optically anisotropic substrate 23 disposed with a space formed through a spacer 20. Transparent conductive films (not shown) are formed on respective inner surfaces of the glass substrate 19 and the optically anisotropic substrate 23. For the optically anisotropic substrate 23, for example, a drawn PET film is used. A drawing axis of the optically anisotropic substrate 23 is set to an angle of about 45 degrees with respect to a polarization axis of a polarizing plate 3 disposed on the liquid crystal panel 30. With this, image light emitted from the polarizing plate 3, which has linear polarization, is converted into circular polarization or elliptical polarization. As a result, even when a displayed image is viewed through sunglasses or a camera having polarization property, angle dependence of the displayed image is mitigated. The optically anisotropic substrate 23 desirably has a function of a ¼λ phase difference plate.

The touch panel 22 is pressed from an optically anisotropic substrate 23 side, and hence the transparent conductive film formed on the glass substrate 19 and the transparent conductive film formed on the transparent substrate 23 are brought into contact with each other. A position of the contact point is detected by a resistance detection circuit. For the touch panel 22, in addition to the analog resistance film type as in this embodiment, a digital resistance film type, an electrostatic capacitance type, and an ultrasonic wave type may be used.

### Fourteenth Embodiment

FIG. 14 is a schematic longitudinal sectional view illustrating a display device according to a fourteenth embodiment of the present invention. The same parts or parts having the same functions are denoted by the same reference numerals.

In FIG. 14, the fourteenth embodiment is different from the thirteenth embodiment in that the touch panel 22 and the liquid crystal panel 30 are bonded and fixed to each other through the optical adhesive 8. Other structures are the same as those of the thirteenth embodiment, and therefore descriptions thereof are omitted. The optical adhesive 8 is applied over the entire surface of the display region of the liquid crystal panel 30. A refractive index of the optical adhesive 8 is closer to a refractive index than air with respect to the glass substrate 19 and the polarizing plate 3. Accordingly, in respective interfaces between the glass substrate 19 and the optical adhesive 8 and between the optical adhesive 8 and the polarizing plate 3, reflection loss of light is reduced. As a result, surface glare due to reflection of external light and reflection loss of light emitted from backlight are reduced to thereby increase visibility of a displayed image.

### INDUSTRIAL APPLICABILITY

The display device may be used as a display device of a portable device, to which a drop impact is given and in which display surface is pressed, and as a display device of a device used in the outside.

1. A display device, comprising:
a liquid crystal panel which includes two transparent substrates sandwiching liquid crystals therebetween and an optical film placed on at least one of outer surfaces of the two transparent substrates;
a first glass plate which is attached on a display surface side of the liquid crystal panel through a first adhesive made of an optical adhesive or a translucent bonding sheet; and
a second glass plate which is attached on a rear surface side of the liquid crystal panel through a second adhesive made of then optical adhesive or the translucent bonding sheet.

2. A display device according to claim 1, wherein an outer shape of the second glass plate is larger than an outer shape of the first glass plate.

3. A display device according to claim 1, wherein a thickness of the second glass plate is larger than a thickness of the first glass plate.

4. A display device according to claim 1, wherein the second glass plate serves as a light guide plate which guides backlight to the liquid crystal panel.

5. A display device according to claim 1, further comprising an optically anisotropic film disposed between the liquid crystal panel and the first glass plate.

6. A display device according to claim 1, wherein the first adhesive is an optically anisotropic adhesive.

7. A display device according to claim 6, wherein the optically anisotropic adhesive is formed by mixing liquid crystals in a photo-curable adhesive.

8. A display device according to claim 1, further comprising an anti-scattering film placed on a surface of the first glass plate.

9. A display device according to claim 1, further comprising a touch panel which is disposed on the display surface side of the liquid crystal panel and formed by attaching the first glass plate and a transparent substrate to each other through a space.

10. A display device, comprising:
a display panel including a polarizing plate disposed on a display surface side thereof;
a translucent member disposed on the display surface side; and
an optical member having optical anisotropy or an optical member canceling linear polarization, which is disposed between the polarizing plate and the translucent member.

11. A display device according to claim 10, wherein the optical member is an optically anisotropic film or a linear polarization canceling film.

12. A display device according to claim 10, wherein:
the optical member is an optically anisotropic adhesive or an optically anisotropic bonding sheet; and
the display panel and the translucent member are bonded to each other over an entire surface of a display region of the display panel through the polarizing plate.

13. A display device according to claim 10, wherein the translucent member is a glass plate, a translucent plastic plate, or a touch panel.

14. A display device according to claim 10, further comprising a touch panel which is disposed on the display surface side of the display panel and formed by attaching two transparent substrates to each other through a space,
wherein at least one of the two transparent substrates is formed of the optical member.

15. A display device according to claim 14, wherein the touch panel and the display panel are bonded to each other over the entire surface of the display region of the display panel with a use of an optical adhesive.
